(19) United States
(12) Patent Application Publication
(10) Pub. No.: US 2007/0086541 A1
(43) Pub. Date: Apr. 19, 2007

(54) Apparatus and method for processing LLR for error correction code in a mobile communication system

(75) Inventors: June Moon, Seoul (KR); Seul-Ki Bae, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/582,500

(22) Filed: Oct. 18, 2006

(30) Foreign Application Priority Data
Oct. 18, 2005 (KR) 2005-0097848

(51) Int. Cl. H04L 1/02

(52) U.S. Cl. 375/267

(57) ABSTRACT

An apparatus and method for scaling an LLR for an error correction code in a mobile communication system are provided. In the LLR scaling apparatus, an environment factor controller decides an environment factor according to a radio channel environment. A scaling factor generator generates a scaling factor using the environment factor and a received LLR. A multiplier then multiplies the LLR by the scaling factor to scale the LLR.

### CROSS-REFERENCE TO RELATED APPLICATIONS

This application claims the benefit under 35 U.S.C. §119(a) of Korean Patent Application No. 10-2005-0097848, filed in the Korean Intellectual Property Office on Oct. 18, 2005, the entire disclosure of which is incorporated herein by reference.

### BACKGROUND OF THE INVENTION

1. Field of the Invention

The present invention relates generally to a Log Likelihood Ratio (LLR) processing apparatus and method in a mobile communication system. In particular, the present invention relates to an apparatus and method for efficiently scaling LLR values input to a Forward Error Correction (FEC) decoder according to channel environment or system performance in a mobile communication system.

2. Description of the Related Art

In a mobile communication system, a decoder performs soft decision decoding to correct errors of a received signal. Specifically, the decoder generates soft decision values corresponding to channel-encoded bits from the two-dimensional signal composed of in-phase signal components and quadrature-phase signal components. Typically, the soft decision values are represented by LLR values, which are expressed as shown in Equation (1) below, in the case of Additive White Gaussian Noise (AWGN) and Binary Phase Shift Keying (BPSK),

$$Λ = log ( \frac{p ( y \text{\vert} c = 0 )}{p ( y \text{\vert} c = 1 )} ) = \frac{2 y}{{σ}^{2}} \qquad ( 1 )$$

wherein c represents transmitted bits, y represents the received signal, and σ² is an average noise. Thus, the LLRs are calculated by estimating the average noise σ² and scaling the received signal y correspondingly.

If the LLRs are rapidly saturated or truncated due to a channel change, they are quantized to x-bit discrete values prior to input to the decoder, thereby ensuring decoding performance. Decoder complexity depends primarily on the x value. Accordingly, the x value needs to be optimized by simulating the performance of a real communication environment.

For LLR quantization, the LLRs are scaled according to predetermined quantization levels.

For convolutional-type codes (e.g. a convolutional code and a turbo code), conventionally, the LLRs are normalized by scaling so that their mean Λ̅ is constant. For this purpose, a scaling factor is changed according to the mean Λ̅ and input LLRs.

However, if the mean of the scaled LLRs is constant, LLRs fluctuate significantly, leading to mismatch between the LLRs and quantization levels in a system supporting a variety of modulation levels and code rates under a Multiple-Input Multiple-Output (MIMO) environment or a fading channel environment. As a consequence, system performance is degraded.

Accordingly, a need exist for a system and method for scaling LLR values input to a decoder that maintains or improves system performance.

### SUMMARY OF THE INVENTION

An object of embodiments of the present invention is to substantially solve at least the above problems and/or disadvantages and to provide at least the advantages described below. Accordingly, an object of embodiments of the present invention is to provide an apparatus and method for efficiently scaling LLRs to support a variety of modulation levels and code rates according to changes of a radio channel in a mobile communication system.

Another object of embodiments of the present invention is to provide an apparatus and method for efficiently scaling LLRs by changing the mean of scaled LLRs according to a radio channel environment in a mobile communication system.

A further object of embodiments of the present invention is to provide an apparatus and method for scaling LLRs which vary highly with changes of a radio channel, to quantization levels suitable for a quantizer in a mobile communication system.

The above objects are achieved by providing an apparatus and method for scaling an LLR for an error correction code in a mobile communication system.

According to one aspect of embodiments of the present invention, an apparatus for scaling an LLR for an error correction code in a mobile communication system is provided, wherein an environment factor controller decides an environment factor according to a radio channel environment. A scaling factor generator generates a scaling factor using the environment factor and a received LLR. A multiplier then multiplies the LLR by the scaling factor to scale the LLR.

According to another aspect of embodiments of the present invention, an apparatus for scaling an LLR for an error correction code in a mobile communication system is provided, wherein an environment factor controller decides an environment factor according to a radio channel environment. A reference quantization level generator decides a reference quantization level using the environment factor and a received LLR. A quantizer then quantizes the LLR using the reference quantization level.

According to a further aspect of embodiments of the present invention, a method of scaling an LLR for an error correction code in a mobile communication system is provided, wherein an environment factor is selected according to a radio channel environment. A scaling factor is calculated using the environment factor. A received LLR is then scaled by multiplying the LLR by the scaling factor.

According to still another aspect of embodiments of the present invention, a method of scaling an LLR for an error correction code in a mobile communication system is provided, wherein an environment factor is selected according to a radio channel environment and a scaling factor is calculated using the environment factor. A reference quantization level is calculated using the scaling factor and a received LLR. The LLR is then quantized using the reference quantization level.

### BRIEF DESCRIPTION OF THE DRAWINGS

The above and other objects, features and advantages of embodiments of the present invention will become more apparent from the following detailed description when taken in conjunction with the accompanying drawings, in which:

FIG. 1 is a block diagram of a receiver in a mobile communication system according to embodiments of the present invention;

FIG. 2 is a block diagram of an LLR scaler according to an exemplary embodiment of the present invention;

FIG. 3 is a block diagram of an LLR scaler according to another exemplary embodiment of the present invention;

FIG. 4 is a flowchart illustrating an exemplary LLR scaling operation according to an embodiment of the present invention; and

FIG. 5 is a flowchart illustrating an exemplary LLR scaling operation according to another embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will be described herein below with reference to the accompanying drawings. In the following description, well-known functions or constructions are not described in detail since they would obscure the invention in unnecessary detail.

The present invention is intended to provide an LLR processing technique that is applicable to a mobile communication system supporting a variety of channel environments. While the following description is made in the context of a Multiple-Input Multiple-Output-Orthogonal Frequency Division Multiplexing (MIMO-OFDM) wireless communication system, it is to be understood that embodiments of the present invention are also applicable to any wireless communication system as far as it uses an LLR-based channel decoder. Preferably, LLR scaling is performed on an FEC code block basis, however embodiments of the present invention are not limited thereto. Thus, the LLR scaling can be done on any other predetermined basis (e.g. an OFDM symbol) depending on hardware design requirements.

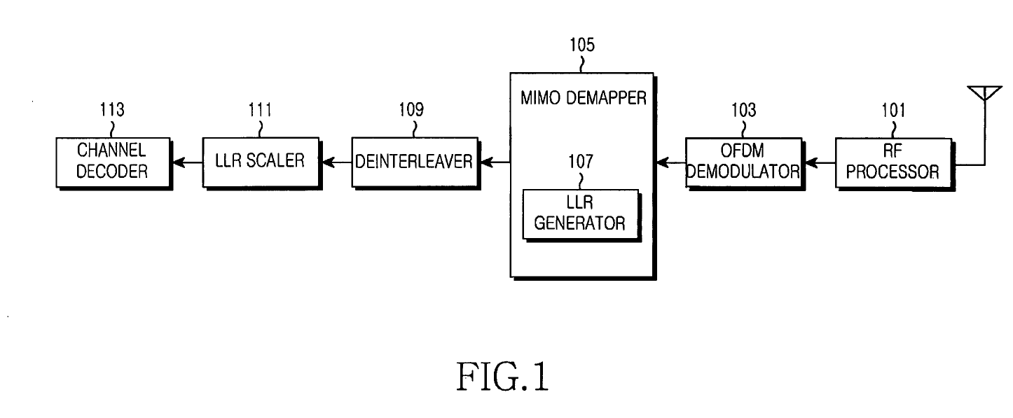

FIG. 1 is a block diagram of a receiver in a mobile communication system according to embodiments of the present invention.

Referring to FIG. 1, the receiver comprises a Radio Frequency (RF) processor 101, an OFDM demodulator 103, a MIMO demapper 105, a deinterleaver 109, an LLR scaler 111, and a channel decoder 113.

The RF processor 101 downconverts an RF signal received through an antenna into a baseband signal. The OFDM demodulator 103 converts the time-domain signal received from the RF processor 101 into a frequency-domain signal by Fast Fourier Transform (FFT).

The MIMO demapper 105 including an LLR generator 107, selects signals carrying actual data among the OFDM-demodulated signals and calculates the LLRs of the selected signals. The deinterleaver 109 then deinterleaves the LLRs.

The LLR scaler 111 scales the deinterleaved LLRs according to predetermined quantization levels and quantizes the scaled LLRs. For the LLR scaling, the LLR scaler 111 generates a scaling factor using an environment factor corresponding to the radio channel environment of the received signal and the LLRs.

The channel decoder 113 then channel-decodes the quantized signals at a predetermined code rate, thereby recovering information data.

In exemplary embodiments of the present invention, since the LLR scaling follows the deinterleaving, an LLR scaling unit is a codeword length. It can be further contemplated in yet another exemplary embodiment of the present invention that the LLR scaling precedes the deinterleaving and thus, the LLR scaling unit is the total number of bits per OFDM symbol.

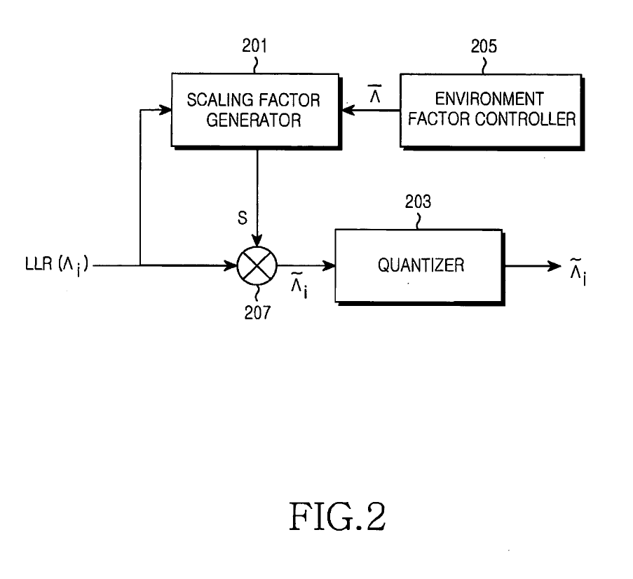

FIG. 2 is a block diagram of an exemplary LLR scaler 111 according to an embodiment of the present invention.

Referring to FIG. 2, the LLR scaler 111 comprises a scaling factor generator 201, a quantizer 203, an environment factor controller 205, and a multiplier 207.

The scaling factor generator 201 computes a scaling factor S using LLRs Λᵢ received from the deinterleaver 109 and an environment factor Λ̅ determined according to the radio channel environment of the received signal by the environment factor controller 205 according to Equation (2) and Equation (3) below,

$$\frac{1}{N} {\sum }_{i = 1}^{N} \vert {\tilde{Λ}}_{i} \vert = S \frac{1}{N} {\sum }_{i = 1}^{N} \vert {Λ}_{i} \vert = \overline{Λ} \qquad ( 2 )$$

wherein N represents a predetermined LLR scaling unit (e.g. an FEC block or an ODM symbol) expressed as the number of samples. If LLR scaling is performed on an FEC block basis, N is a codeword length. If LLR scaling is performed on an OFDM symbol basis, N is the total number of bits in the OFDM symbol.

In Equation (2), \tilde{Λ}ᵢ represents scaled LLRs, Λᵢ represents the LLRs before the scaling, S is the scaling factor, and Λ̅ is the environment factor.

Therefore, the scaling factor generator 201 computes the scaling factor S according to Equation (3) below,

$$S = \frac{N \overline{Λ}}{{\sum }_{i = 1}^{N} \vert {Λ}_{i} \vert} \qquad ( 3 )$$

wherein S represents the scaling factor, Λ̅ represents the environment factor, N represents a predetermined LLR scaling unit (e.g. an FEC block or an ODM symbol) expressed as the number of samples, and Λ̅ᵢ represents the LLRs before the scaling.

Equation (3) reveals that the scaling factor S is affected by both the input LLRs Λ̅ᵢ and the environment factor Λ̅.

The environment factor controller 205 decides the environment factor Λ̅ according to the radio channel environment and provides it to the scaling factor generator 201. The scaling factor generator 201 generates a scaling factor using the environment factor and a received LLR, and the multiplier 207 multiplies the LLR by the scaling factor to scale the LLR and provides the scaled LLR to the quantizer 203.

The environment factor Λ̅ is equal to the scaled LLRs as noted from Equation (2). That is, the environment factor controller 205 provides the environment factor Λ̅ for deciding the scaling factor S which leads to scaling of the LLRs according to the radio channel environment of the received signal and thus, enables the channel decoder 113 to adaptively operate according to various radio channel environments. The environment factor Λ̅ is decided according to a code rate, modulation level (e.g. BPSK, Quadrature Phase Shift Keying (QPSK), or 16-ary Quadrature Amplitude Modulation (16 QAM)), MIMO information (e.g. number of antennas, number of streams, spatial multiplexing, spatial diversity, and so forth). Preferably, optimum environment factors for various and different environments are empirically calculated and tabulated into an environment factor table. The environment factor controller 205 can comprise any suitable memory device for storage, update and maintenance of the environment factor table.

The quantizer 203 quantizes the scaled LLRs \tilde{Λ}ᵢ and provides the quantized LLRs \hat{Λ}ᵢ to the channel decoder 113.

In the above described exemplary embodiment of the present invention illustrated in FIG. 2, LLRs are scaled according to quantization levels of the quantizer 203 using a scaling factor calculated according to a radio channel environment.

It can be further contemplated in yet another embodiment of the present invention that the quantization levels of the quantizer 203 can be changed for quantizing the LLRs, instead of scaling the LLRs according to the quantization levels.

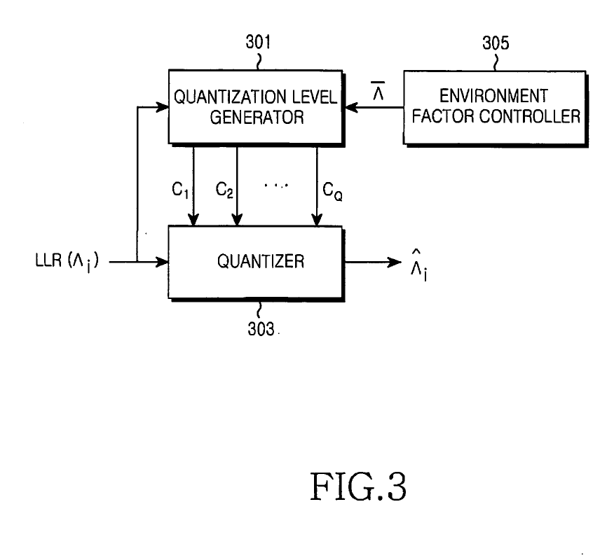

FIG. 3 is a block diagram of an exemplary LLR scaler according to another embodiment of the present invention.

Referring to FIG. 3, the LLR scaler 111 comprises a quantization level generator 301, a quantizer 303, and an environment factor controller 305.

The quantization level generator 301 determines quantization levels according to Equation (4), Equation (5) and Equation (6) below using the LLRs A received from the deinterleaver 109 and an environment factor Λ̅ᵢ received from the environment factor controller 305,

$${\tilde{c}}_{q} \leq ( \tilde{Λ} = S {Λ}_{i} = \frac{N \overline{Λ}}{{\sum }_{i = 1}^{N} \vert {Λ}_{i} \vert} {Λ}_{i} ) < {\tilde{c}}_{q + 1} \qquad ( 4 )$$

wherein \tilde{c}_{q} represents predetermined quantization levels, \tilde{Λ} represents scaled LLRs, S represents a scaling factor, Λᵢ represents the LLRs before the scaling, Λ̅ represents the environment factor, and N represents a predetermined LLR scaling unit (e.g. an FEC block or an ODM symbol) expressed as the number of samples. If LLR scaling is performed on an FEC block basis, N is a codeword length. If LLR scaling is performed on an OFDM symbol basis, N is the total number of bits in the OFDM symbol.

For the LLRs Λᵢ, Equation (4) can be expressed as Equation (5) below,

$$\frac{{\sum }_{i = 1}^{N} \vert {Λ}_{i} \vert}{N \overline{Λ}} {\tilde{c}}_{q} \leq {Λ}_{i} < \frac{{\sum }_{i = 1}^{N} \vert {Λ}_{i} \vert}{N \overline{Λ}} {\tilde{c}}_{q + 1} \qquad ( 5 )$$

wherein \tilde{c}_{q} represents the predetermined quantization levels, Λᵢ represents the LLRs before the scaling, Λ̅ represents the environment factor, and N represents the predetermined LLR scaling unit (e.g. an FEC block or an ODM symbol) expressed as the number of samples.

Equation (5) can then be simplified into Equation (6) below,

$${c}_{q} \leq {Λ}_{i} < {c}_{q + 1} ( {c}_{q} = \frac{{\sum }_{i = 1}^{N} \vert {Λ}_{i} \vert}{N \overline{Λ}} {\tilde{c}}_{q} ) \qquad ( 6 )$$

wherein \tilde{c}_{q} represents the predetermined quantization levels, Λᵢ represents the LLRs before the scaling, Λ̅ represents the environment factor, and N represents the predetermined LLR scaling unit (e.g. an FEC block or an ODM symbol) expressed as the number of samples.

As noted from Equation (6), the quantization levels of the quantizer 303 are determined using the LLRs Λ̅ᵢ and the environment factor Λ̅.

The environment factor controller 305 decides the environment factor Λ̅ according to the radio channel environment and provides it to the quantization level generator 301.

That is, the environment factor controller 305 provides the environment factor Λ̅ for deciding the quantization levels which leads to quantization of the LLRs according to the radio channel environment of the received signal and thus, enables the channel decoder 113 to adaptively operate according to various radio channel environments. The environment factor Λ̅ is decided according to a code rate, modulation level (e.g. BPSK, QPSK, or 16 QAM), MIMO information (e.g. number of antennas, number of streams, spatial multiplexing, spatial diversity, and so forth). Preferably, optimum environment factors for various and different environments are empirically calculated and tabulated into an environment factor table. The environment factor controller 305 can comprise any suitable memory device for storage, update and maintenance of the environment factor table.

The quantizer 303 quantizes the LLRs to the quantization levels and provides the quantized LLRs \hat{Λ}ᵢ to the channel decoder 113.

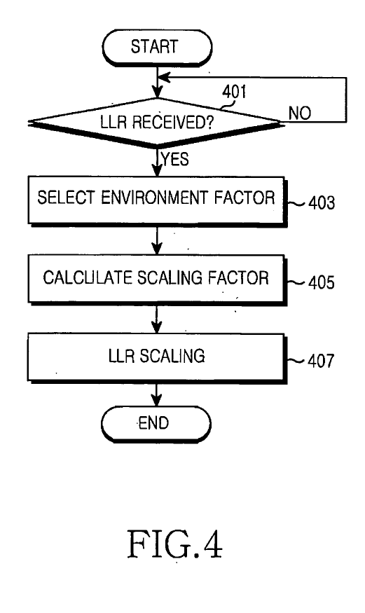

FIG. 4 is a flowchart illustrating an exemplary LLR scaling operation according to an embodiment of the present invention.

Referring to FIG. 4, the LLR scaler 111 monitors reception of deinterleaved LLRs Λᵢ of a received signal in step 401. Upon receipt of the LLRs Λᵢ, the LLR scaler 111 selects an environment factor Λ̅ corresponding to the radio channel environment of the received signal from a predetermined environment factor table in the environment factor controller 205 in step 403.

In step 405, the LLR scaler 111 calculates a scaling factor S for LLR scaling by executing Equation (3) using the selected environment factor Λ̅ and the received LLRs Λᵢ.

The LLR scaler 111 then scales the LLRs Λᵢ by multiplying the LLRs Λᵢ by the scaling factor S in step 407 and ends the algorithm.

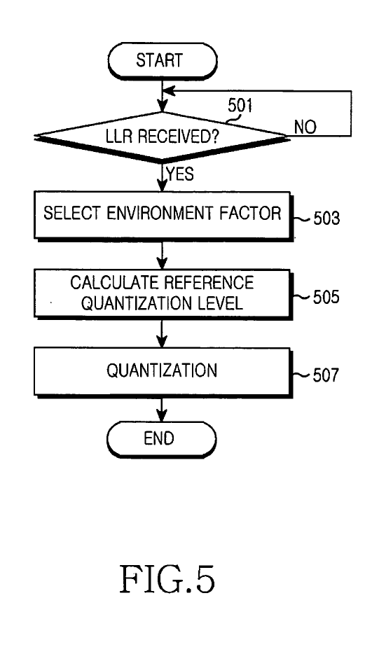

FIG. 5 is a flowchart illustrating an exemplary LLR scaling operation according to another embodiment of the present invention.

Referring to FIG. 5, the LLR scaler 111 monitors reception of deinterleaved LLRs Λᵢ of a received signal in step 501. Upon receipt of the LLRs Λᵢ, the LLR scaler 111 selects an environment factor Λ̅ corresponding to the radio channel environment of the received signal from a predetermined environment factor table in the environment factor controller 205 in step 503.

In step 505, the LLR scaler 111 calculates reference quantization levels for the quantizer 303 by executing Equation (6) using the selected environment factor Λ̅ and the received LLRs Λᵢ.

The LLR scaler 111 then quantizes the LLRs Λᵢ to the quantization levels and provides the quantized LLRs to the channel decoder 113 in step 507 and ends the algorithm.

In accordance with the embodiments of present invention as described above, LLRs are efficiently scaled by changing the mean of scaled LLRs according to a radio channel environment in a mobile communication system. Therefore, a decoder can adaptively operate according to MIMO schemes, such as a variety of modulation levels and code rates, number of streams, number of transmit/receive antennas, spatial diversity, and spatial multiplexing. In addition, since the discrete bit values of LLRs input to the decoder are reduced, decoder complexity is decreased.

The present invention can also be embodied as computer readable code on a computer readable recording medium. The computer readable recording medium comprises any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

While the present invention has been shown and described with reference to certain exemplary embodiments thereof, it will be understood by those skilled in the art that various changes in form and detail may be made therein without departing from the spirit and scope of the invention as defined by the appended claims and equivalents.

What is claimed is:

1. An apparatus for scaling a Log Likelihood Ratio (LLR) for an error correction code in a mobile communication system, comprising:
an environment factor controller for deciding an environment factor according to a radio channel environment;
a scaling factor generator for generating a scaling factor using the environment factor and a received LLR; and
a multiplier for multiplying the LLR by the scaling factor to scale the LLR.

2. The apparatus of claim 1, wherein the environment factor changes according to the radio channel environment and is proportional to the scaled LLR.

3. The apparatus of claim 1, wherein the environment factor controller is configured to store an environment factor table listing environment factors with respect to radio channel environments, and decide the environment factor for the LLR scaling.

4. The apparatus of claim 1, wherein the radio channel environment is decided based upon Multiple-Input Multiple-Output (MIMO) information comprising at least one of a code rate, a modulation level, a number of streams, a number of transmit/receive antennas, spatial diversity and spatial multiplexing.

5. The apparatus of claim 1, wherein the scaling is performed on a Forward Error Correction (FEC) block basis or on an Orthogonal Frequency Division Multiplexing (OFDM) symbol basis.

6. The apparatus of claim 1, further comprising a quantizer for quantizing the scaled LLR.

7. The apparatus of claim 1, wherein the scaling factor generator is configured to calculate the scaling factor by using equation,
$$S = \frac{N \overline{Λ}}{{\sum }_{i = 1}^{N} \vert {Λ}_{i} \vert}$$
wherein S represents the scaling factor, N is a number of samples, Λ̅ represents the environment factor, and Λᵢ represents the received LLR.

8. An apparatus for scaling a Log Likelihood Ratio (LLR) for an error correction code in a mobile communication system, comprising:
an environment factor controller for deciding an environment factor according to a radio channel environment;
a reference quantization level generator for deciding a reference quantization level using the environment factor and a received LLR; and
a quantizer for quantizing the LLR using the reference quantization level.

9. The apparatus of claim 8, wherein the environment factor changes according to the radio channel environment and is proportional to a scaled LLR.

10. The apparatus of claim 8, wherein the environment factor controller is configured to store an environment factor table listing environment factors with respect to radio channel environments.

11. The apparatus of claim 8, wherein the radio channel environment is decided based upon Multiple-Input Multiple-Output (MIMO) information comprising at least one of a code rate, a modulation level, a number of streams, a number of transmit/receive antennas, spatial diversity and spatial multiplexing.

12. The apparatus of claim 8, wherein the reference quantization level generator is configured to calculate the reference quantization level by using equation,
$${c}_{q} \leq {Λ}_{i} < {c}_{q + 1} ( {c}_{q} = \frac{{\sum }_{i = 1}^{N} \vert {Λ}_{i} \vert}{N \overline{Λ}} {\tilde{c}}_{q} )$$
wherein Λᵢ represents the received LLR, N represents a number of samples, Λ̅ represents the environment factor, and \tilde{c}_{q} represents a predetermined reference quantization level.

13. A method of scaling a Log Likelihood Ratio (LLR) for an error correction code in a mobile communication system, comprising the steps of:
selecting an environment factor according to a radio channel environment;
calculating a scaling factor using the environment factor; and
scaling a received LLR by multiplying the LLR by the scaling factor.

14. The method of claim 13, wherein the environment factor changes according to the radio channel environment and is proportional to the scaled LLR.

15. The method of claim 13, wherein the environment factor selection step comprises the step of selecting the environment factor corresponding to the radio channel environment from an environment factor table listing environment factors with respect to radio channel environments.

16. The method of claim 13, wherein the radio channel environment is decided based upon Multiple-Input Multiple-Output (MIMO) information comprising at least one of a code rate, a modulation level, a number of streams, a number of transmit/receive antennas, spatial diversity and spatial multiplexing.

17. The method of claim 13, wherein the scaling step comprises the step of performing the scaling on a Forward Error Correction (FEC) block basis or on an Orthogonal Frequency Division Multiplexing (OFDM) symbol basis.

18. The method of claim 13, further comprising the step of quantizing the scaled LLR.

19. The method of claim 13, wherein the scaling factor calculation step comprises the step of calculating the scaling factor by using equation,
$$S = \frac{N \overline{Λ}}{{\sum }_{i = 1}^{N} \vert {Λ}_{i} \vert}$$
wherein S represents the scaling factor, N represents a number of samples, Λ̅ represents the environment factor, and Λᵢ represents the received LLR.

20. A method of scaling a Log Likelihood Ratio (LLR) for an error correction code in a mobile communication system, comprising the steps of:
selecting an environment factor according to a radio channel environment;
calculating a reference quantization level using the environment factor and a received LLR; and
quantizing the LLR using the reference quantization level.

21. The method of claim 20, wherein the environment factor changes according to the radio channel environment and is proportional to a scaled LLR.

22. The method of claim 20, wherein the environment factor selection step comprises the step of selecting the environment factor corresponding to the radio channel environment from an environment factor table listing environment factors with respect to radio channel environments.

23. The method of claim 20, wherein the radio channel environment is decided based upon Multiple-Input Multiple-Output (MIMO) information comprising at least one of a code rate, a modulation level, a number of streams, a number of transmit/receive antennas, spatial diversity and spatial multiplexing.

24. The method of claim 20, wherein the reference quantization level calculation step comprises the step of calculating the reference quantization level by using equation,
$${c}_{q} \leq {Λ}_{i} < {c}_{q + 1} ( {c}_{q} = \frac{{\sum }_{i = 1}^{N} \vert {Λ}_{i} \vert}{N \overline{Λ}} {\tilde{c}}_{q} )$$
wherein Λᵢ represents the received LLR, N represents a number of samples, Λ̅ represents the environment factor, and \tilde{c}_{q} represents a predetermined reference quantization level.

25. An apparatus for scaling a Log Likelihood Ratio (LLR) for an error correction code in a mobile communication system, comprising:
an LLR scaler receiving an output of the deinterleaver, the LLR scaler comprising an environment factor controller for deciding an environment factor according to a radio channel environment, a scaling factor generator for generating a scaling factor using the environment factor and a received LLR, and a multiplier for multiplying the LLR by the scaling factor to scale the LLR, wherein a LLR scaling unit is a codeword length.

26. An apparatus for scaling a Log Likelihood Ratio (LLR) for an error correction code in a mobile communication system, comprising:
an LLR scaler providing an input of the deinterleaver, the LLR scaler comprising an environment factor controller for deciding an environment factor according to a radio channel environment, a scaling factor generator for generating a scaling factor using the environment factor and a received LLR, and a multiplier for multiplying the LLR by the scaling factor to scale the LLR, wherein a LLR scaling unit is a total number of bits per Orthogonal Frequency Division Multiplexing (OFDM) symbol.

27. An apparatus for generating a scaling factor for scaling a Log Likelihood Ratio (LLR) for an error correction code in a mobile communication system, comprising:
an environment factor controller for deciding an environment factor according to a radio channel environment; and
a scaling factor generator for generating a scaling factor using the environment factor and a received LLR.

28. The apparatus of claim 27, further comprising a multiplier for multiplying the LLR by the scaling factor to scale the LLR.

29. The apparatus of claim 26, wherein the environment factor controller comprises:
a memory adapted to store an environment factor table comprising environment factors with respect to radio channel environments; and
a means to decide the environment factor for the LLR scaling.

30. The apparatus of claim 29, wherein the radio channel environment is decided based upon Multiple-Input Multiple-Output (MIMO) information comprising at least one of a code rate, a modulation level, a number of streams, a number of transmit/receive antennas, spatial diversity and spatial multiplexing.

31. The apparatus of claim 28, wherein the scaling is performed on a Forward Error Correction (FEC) block basis or on an Orthogonal Frequency Division Multiplexing (OFDM) symbol basis.

32. The apparatus of claim 28, further comprising a quantizer for quantizing the scaled LLR.

33. The apparatus of claim 27, wherein the scaling factor generator is configured to calculate the scaling factor by using equation,
$$S = \frac{N \overline{Λ}}{{\sum }_{i = l}^{N} \vert {Λ}_{i} \vert}$$
wherein S represents the scaling factor, N is a number of samples, Λ̅ represents the environment factor, and Λᵢ represents the received LLR.

34. A computer program embodied on a computer-readable medium for scaling a Log Likelihood Ratio (LLR) for an error correction code in a mobile communication system, comprising:
a first set of instructions for selecting an environment factor according to a radio channel environment;
a second set of instructions for calculating a scaling factor using the environment factor; and
a third set of instructions for scaling a received LLR by multiplying the LLR by the scaling factor.

35. A computer program embodied on a computer-readable medium for scaling a Log Likelihood Ratio (LLR) for an error correction code in a mobile communication system, comprising the steps of:
a first set of instructions for selecting an environment factor according to a radio channel environment;
a second set of instructions for calculating a reference quantization level using the environment factor and a received LLR; and
a third set of instructions for quantizing the LLR using the reference quantization level.
